(19) United States
(12) Patent Application Publication
(10) Pub. No.: US 2005/0271117 A1
(43) Pub. Date: Dec. 8, 2005

(54) Measuring system and method for the contactless determination of the body core temperature

(76) Inventors: Thomas Grassl, Lubeck (DE); Jochim Koch, Ratzeburg (DE)

Correspondence Address: MCGLEW & TUTTLE, PC, P.O. BOX 9227, SCARBOROUGH STATION, SCARBOROUGH, NY, 10510-9227, US

(21) Appl. No.: 11/108,192

(22) Filed: Apr. 18, 2005

(30) Foreign Application Priority Data
Jun. 4, 2004 (DE) 10 2004 027 443.6

(51) Int. Cl. G01K 7/00

(52) U.S. Cl. 374/121

(57) ABSTRACT

A measuring system and method for the contactless and continuous determination of the body core temperature of a person/subject preferably includes a matrix-like infrared sensor (3) that is directed toward the nose-side area of the canthus. The infrared sensor (3) is connected with an evaluating unit (5) for the evaluation of the infrared signals and the selection of the maximum in the matrix. The evaluating unit (5) is connected with a computing unit (6) for the calculation of the body core temperature from the maximum determined and for displaying via a display (7) and/or transmission of the measured signals and/or the calculated value for the body core temperature.

### CROSS REFERENCE TO RELATED APPLICATIONS

This application claims the benefit of priority under 35 U.S.C. § 119 of DE 10 2004 027 443.6 filed Jun. 4, 2004, the entire contents of which are incorporated herein by reference.

### FIELD OF THE INVENTION

The present invention pertains to a measuring system for the contactless determination of the body core temperature of a person.

### BACKGROUND OF THE INVENTION

The determination of a temperature near the body is described, for example, with a double temperature sensor corresponding to DE 100 38 247 C2. One drawback of this device and of the corresponding measurement method is the direct contacting with the skin at the measuring site, which leads to errors in measurement, especially when the skin is covered with hair or a measurement is to be performed in the area of the scalp in order to determine the temperature near the core of the body. Furthermore, a temperature measuring device has become known, which is led over the forehead to the temple in order to determine a temperature near the core of the body by determining the skin temperature. The blood vessels are scanned in the process. A temperature near the core of the body can thus be determined from the value of the skin temperature over the blood vessels in relation to the ambient temperature. However, this method is not suitable for continuous use because the temperature sensor would have to be moved continuously over the region being measured. In addition, the method fails when the skin is moist, e.g., due to sweating. Excessively high body core temperatures are obtained in this case.

### SUMMARY OF THE INVENTION

The object of the present invention is to provide a measuring system and method for the contactless and accurate determination of the body core temperature, with which continuous measurement is possible, so that both mission personnel subject to physical stress, for example, police and rescue personnel, and patients being monitored or treated medically are measured continuously.

According to the invention, a measuring system and process are provided for the contactless determination of the body core temperature of a person. An infrared sensor is directed toward the nose-side area of the canthus. The infrared sensor is connected with an evaluating unit for the evaluation of the infrared signal. The evaluating unit is connected with a computing unit for the calculation of the body core temperature from the infrared signal determined and for displaying via a display and/or transmitting of the measured signals and/or of the calculated value for the body core temperature.

An essential advantage of the present invention is the contactless temperature measurement, so that the effect of, e.g., variable contact resistances between the skin and the temperature sensor is ruled out.

Another advantage arises from the use of a flat, matrix-like infrared sensor, which is directed toward the nasal-side canthus in order to thus utilize a reliable correlation between the temperature measured there and the corresponding body core temperature. An area resolution of the surface temperature is possible due to the use of the matrix-like infrared sensor. The evaluating unit may select the maximum in the matrix, and the computing unit may then determine the body core temperature from the maximum.

The infrared sensor is advantageously arranged in a breathing mask or on a helmet in case of firemen or persons subject to physical stress. In case of persons who wear eyeglasses, the infrared sensor is integrated in the bridge of the eyeglasses and directed toward the nose-side area of the canthus.

The measuring system and method may evaluate the infrared signal as a function of the wavelength in reference to measurable biometric variables, especially the oxygen and/or CO₂ concentration in the blood.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic showing of an arrangement of a measuring system for the contactless determination of the body core temperature according to the invention;

FIG. 2 is a schematic showing of the design of a matrix-like infrared sensor for the measuring system of FIG. 1;

FIG. 3 is a schematic view of a directed infrared sensor mounted on a helmet mask;

FIG. 4 is a schematic view of a directed infrared sensor mounted on a protective mask; and

FIG. 5 is a schematic view of a directed infrared sensor mounted on eyeglasses or a nose supported frame.

### DESCRIPTION OF THE PREFERRED EMBODIMENTS

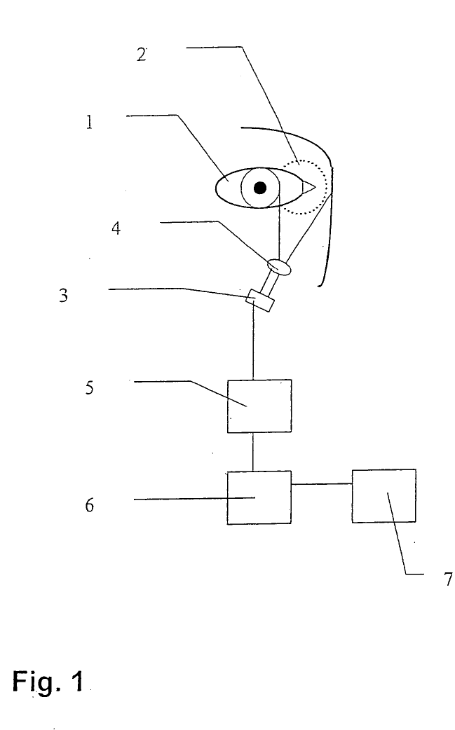

Referring to the drawings in particular, FIG. 1 shows the schematic diagram of an infrared measuring system as it is used here. The canthus area 2 of a human eye 1 is detected by means of the correspondingly directed infrared sensor 3. The ray can be intensified by an optical system 4. The infrared sensor determines the surface temperature in the canthus area 2, which is closely correlated with the body core temperature. The infrared signals are converted by means of a connected evaluating unit into an electric voltage, and, in a preferred embodiment, the value that is the maximum relative to the evaluated area is selected. The body core temperature is calculated in a computing unit connected with the evaluating unit from the infrared signal or from the measured maximum of the surface temperature and the known correlation, displayed on the display 7 and/or transmitted via transmitter to a central evaluating or monitoring station, especially in a wireless manner.

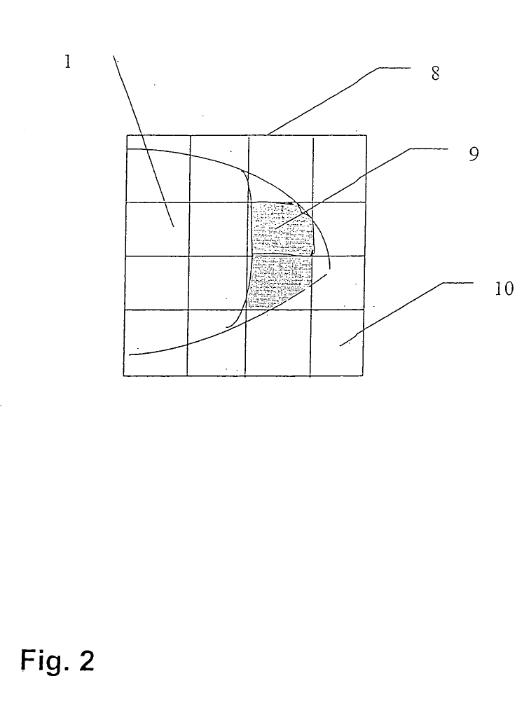

FIG. 2 shows the preferred matrix-like design 8 of an infrared sensor 3 with 4×4=16 fields. This infrared sensor 3 can resolve a surface distribution of different surface radiations and temperatures concerning the maximum. It is consequently able to identify different temperatures of individual area elements within its field of view. It is thus possible to assign individual surface temperatures to small scanned areas, so that surface elements 9 (dark) of higher surface temperatures can be differentiated from those with lower surface temperatures 10. By selecting the maximum in the matrix, the highest temperature with the best correlation is used for the body core temperature to be calculated.

The blood circulation of the retina of the eye can also be determined, in principle, by means of the measuring system described, so that other biometric variables, for example, the oxygen or CO₂ concentration in the blood, can also be measured besides the body core temperature.

The diagnosis and monitoring of infants or comatose patients may be mentioned as a field of application in the area of medicine.

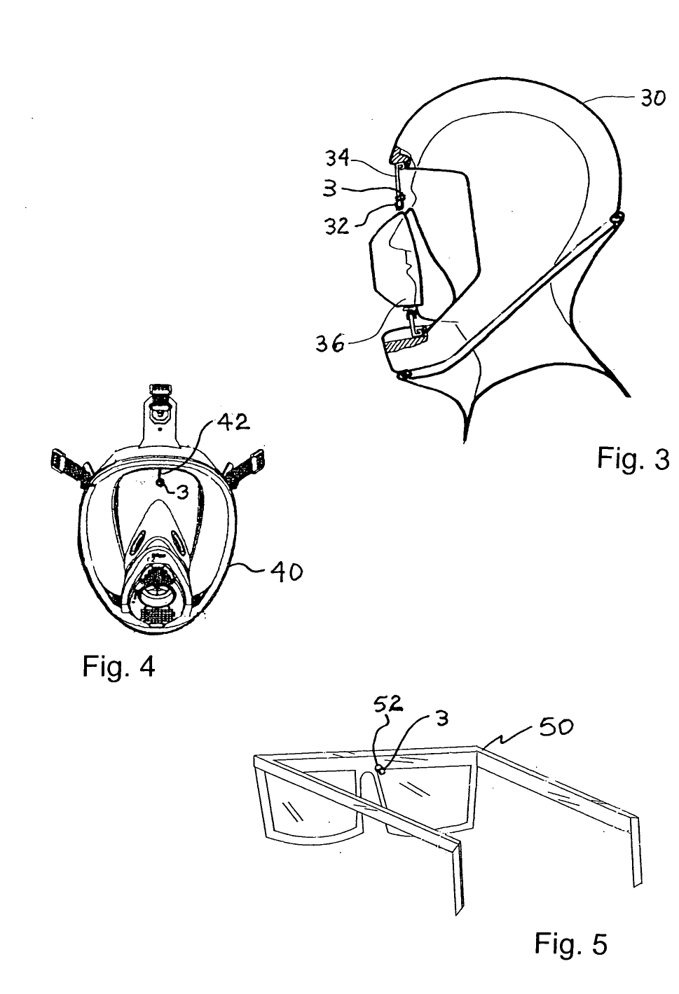

FIGS. 3-5 show the directed infrared sensor 3 mounted on something worn or partially supported by the person or subject for which the core temperature is to be detected. FIG. 3 shows a helmet 30 with a mount 32 that holds the infrared sensor 3, directing the infrared sensor 3 for receiving the infrared energy from the canthus area 2 of a human eye 1. The mount 32 is shown attached to the helmet 30 either directly or to a visor 34 of the helmet 30. The mount 32 may also be attached to a half mask 36. FIG. 4 shows a protective mask 40. The mask 40 has a mount 42 that holds the infrared sensor 3, directing the infrared sensor 3 for receiving the infrared energy from the canthus area 2 of a human eye 1. FIG. 5 shows eyeglasses or a nose and ears supported frame (similar to an eyeglass frame) 50. The frame 50 may also only engage the nose and may also be simultaneously supported by a medical professional taking the measurement (where the bridge/nose piece helps position the infrared sensor 3 on the subject). The infrared sensor 3 is integrated in the bridge of the eyeglasses 50 (with a mount 52) and directed toward the nose-side area of the canthus area 2. The mount 52 and/or the infrared sensor 3 may be retrofitted to existing eyeglasses or special frames 50 (including sets of frames of various sizes) may be provided for supporting the directed infrared sensor 3. The provision of glass in the frames 50 is optional, depending on the needs of the subject. In each of the embodiments of FIGS. 3 and 4 the element 3 can either be located substantially on the symmetry axis or alternatively, this element 3 can be positioned to the left or right of the helmet's symmetry axis of helmet 30 or the visor symmetry axis of visor 34.

While specific embodiments of the invention have been shown and described in detail to illustrate the application of the principles of the invention, it will be understood that the invention may be embodied otherwise without departing from such principles.

1. A measuring system for the contactless determination of the body core temperature of a person, the measuring system comprising:
an infrared sensor directed toward the nose-side area of the canthus of the person;
an evaluating unit, said infrared sensor being connected with said evaluating unit for the evaluation of the infrared signal;
a computing unit, said evaluating unit being connected with said computing unit for a calculation of a body core temperature of the person from the infrared signal determined; and
output means for providing an output of the measured signals and/or of the calculated value for the body core temperature.

2. A measuring system according to claim 1, wherein said output means includes one of a display and a transmitter displaying and/or transmitting the measured signals and/or the calculated value for the body core temperature.

3. A measuring system in accordance with claim 1, wherein the infrared sensor comprises a matrix-like sensor for sensing discrete regions of the nose-side area of the canthus of the person, said evaluating unit selecting a maximum sensed region in the matrix, and the computing unit determines the body core temperature from the maximum.

4. A measuring system in accordance with claim 1, wherein the infrared sensor is arranged in a breathing mask or on a helmet or on eye glasses.

5. A measuring system in accordance with claim 4, wherein the infrared sensor is arranged the bridge of the eyeglasses and directed toward the nose-side area of the canthus.

6. A measuring system in accordance with claim 1, wherein the infrared signal is evaluated as a function of the wavelength in reference to measurable biometric variables.

7. A measuring system in accordance with claim 6, wherein said measurable biometric variables comprise one of oxygen and/or CO₂ concentration in the blood.

8. A method of determining a body core temperature of a subject, the method comprising:
directing an infrared sensor toward the nose-side area of the canthus of the subject to provide an infrared measurement signal;
calculating a body core temperature of the subject from the infrared signal; and
displaying or recording the calculated body core temperature.

9. A method of determining a body core temperature of a subject according to claim 8, wherein prior to said step of displaying or recording, said core temperature of the subject is transmitted from a location of the subject to a location for displaying or recording.

10. A method of determining a body core temperature of a subject according to claim 8, wherein prior to said step of calculating, said infrared measurement signal is transmitted from a location of the subject to a location for said step of calculating.

11. A method of determining a body core temperature of a subject according to claim 8, further comprising evaluating the infrared measurement signal using an evaluating unit, said infrared sensor being operatively connected with the evaluating unit

12. A method of determining a body core temperature of a subject according to claim 8, wherein the infrared sensor comprises a matrix-like sensor for sensing discrete regions of the nose-side area of the canthus of the subject and said infrared measurement signal comprises signal components corresponding to said discrete regions, said evaluating unit selecting a maximum sensed region in the matrix, and the computing unit determines the body core temperature from the maximum.

13. A method of determining a body core temperature of a subject according to claim 8, wherein the infrared sensor is arranged in a breathing mask or on a helmet or on eye glasses and said step of directing an infrared sensor toward the nose-side area of the canthus of the subject includes the subject donning or wearing the breathing mask, helmet or eye glasses.

14. A method of determining a body core temperature of a subject according to claim 11, wherein the infrared signal is evaluated as a function of the wavelength in reference to measurable biometric variables.

15. A method of determining a body core temperature of a subject according to claim 14, wherein said measurable biometric variables comprise one of oxygen and/or CO₂ concentration in the blood.

16. A measuring system for the contactless determination of the body core temperature of a subject, the measuring system comprising:
infrared sensor means for receiving infrared energy from the nose-side area of the canthus of the subject;
calculating means for calculating a body core temperature of the subject from the infrared signal; and
means for displaying or recording the calculated body core temperature.

17. A measuring system according to claim 16, further comprising transmitting means for transmitting the core temperature of the subject from a location of the subject to a location for displaying or recording.

18. A measuring system claim 16, further comprising transmitting means transmitting said infrared measurement signal from a location of the subject to a location of said calculating means.

19. A measuring system according to claim 16, further comprising an evaluating unit for evaluating said measurement signal prior to calculating said core temperature, said infrared sensor being operatively connected with the evaluating unit.

20. A measuring system according to claim 19, wherein the infrared sensor comprises a matrix-like sensor for sensing discrete regions of the nose-side area of the canthus of the subject and said infrared measurement signal comprises signal components corresponding to said discrete regions, said evaluating unit selecting a maximum sensed region in the matrix, and the computing means determining the body core temperature from the maximum.
